(19) United States
(12) Patent Application Publication
(10) Pub. No.: US 2004/0029409 A1
(43) Pub. Date: Feb. 12, 2004

(54) Interface for personal digital assistant accessory

(75) Inventors: Brian James Moon, San Diego, CA (US); Jason Clement, San Diego, CA (US); Koji Kimura, San Diego, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ (US)

(21) Appl. No.: 10/217,560

(22) Filed: Aug. 12, 2002

(51) Int. Cl. H01R 12/00

(52) U.S. Cl. 439/65

(57) ABSTRACT

A PCMCIA component such as a modem is connected to a PDA by means of a component interface that eliminates the need for a “sled”. The interface includes 68 or more female sockets (for full PCMCIA) or 50 female sockets (for mini-PCMCIA) on the PDA and compression-loaded male pins on the component that electrically engage sockets on the PDA. The PCMCIA component is held to the PDA without using a sled.

### I. FIELD OF THE INVENTION

The present invention relates generally to portable computer devices.

### II. BACKGROUND OF THE INVENTION

Portable computers such as personal digital assistants (PDAs) like the Sony Clie® can be attached to many different accessories. Examples of such accessories include printers and personal computer memory card interface architecture (PCMCIA) components such as wireless modems for communicating with, e.g., the Internet.

It happens that many PDAs are configured with a standard universal serial bus (USB) port for effecting electrical connectivity with accessories. Because a USB connector is configured differently than a PCMCIA connector, a so-called “sled” must be used to interconnect, both mechanically and electrically, the PCMCIA component and the PDA. The sled essentially has a PCMCIA port to engage the PCMCIA component and a USB port to engage the PDA, with ports of the sled being connected to each other through a wire network that is inside the sled. The sled itself is configured to mechanically engage the PDA.

As recognized herein, the above-described “sled” solution suffers several drawbacks. One is that a new sled type must be provided every time the electrical or mechanical design of the PDA changes. Also, most sleds are relatively large, in some instances larger than the PDA, which detracts from the portability of the system. Moreover, the external interface of the PDA itself requires modification from time to time to support newer, faster PCMCIA components such as modems. Further, because a sled mechanically engages the PDA, sleds in general can be used only with a single type of PDA, and cannot be used with PDAs with which the sled is not mechanically compatible. And, sleds represent an additional cost in a very competitive market.

As also recognized herein, past solutions that seek to eliminate the sled are deficient. For instance, simply integrating the sled into the PDA significantly increases the size of the PDA, detracting from its portability. Also, this solution does not address the potential desire of the consumer to be able to use a PCMCIA accessory with another, different PDA that does not have an integrated sled without using an external sled. Providing a PCMCIA electrical connection directly in the PDA has also proven deficient because a sled is still required to physically hold the PCMCIA component onto the PDA.

Having recognized the above problems, the present invention has been provided.

### SUMMARY OF THE INVENTION

A personal digital assistant (PDA) is disclosed that has sixty eight (68) female sockets configured to satisfy personal computer memory card interface architecture (PCMCIA) requirements. A component such as a PCMCIA card is detachably engaged with the PDA. Compression-loaded male pins, such as but not limited to pogo pins disposed on a resilient substrate, are on the component for engaging respective female sockets on the PDA without the need for a sled.

In one preferred non-limiting embodiment, a guide pin can be provided on the component for guiding the component into proper alignment with the PDA. Also, one or more abutments can be on the component for engaging, in an interference fit, catch holes on the PDA. If desired, seventy two (72) sockets can be on the PDA to support additional non-PCMCIA signalling.

In another aspect, a personal computer memory card interface architecture (PCMCIA) component includes a component substrate and plural compression-loaded male pins on the substrate, with the pins being engageable with respective female sockets on a PDA.

In still another aspect, a method for engaging a component with a portable computer includes providing at least sixty eight sockets on one of: the component, and computer, and providing plural pins on the other of: the component, and the computer. The pins are compression loaded such that when the component and computer are engaged the pins are biased against the sockets. The method includes holding the component onto the computer without using a sled.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of the combined PDA/PCMCIA component system of the present invention, shown engaged with a synchronization host processor;

FIG. 2 is a side view of the PDA and the PCMCIA component in an exploded relationship; and

FIG. 3 is a bottom view of the PDA, showing the female sockets, with the socket door removed for clarity.

### DETAILED DESCRIPTION OF THE PREFERRED EMBODIMENT

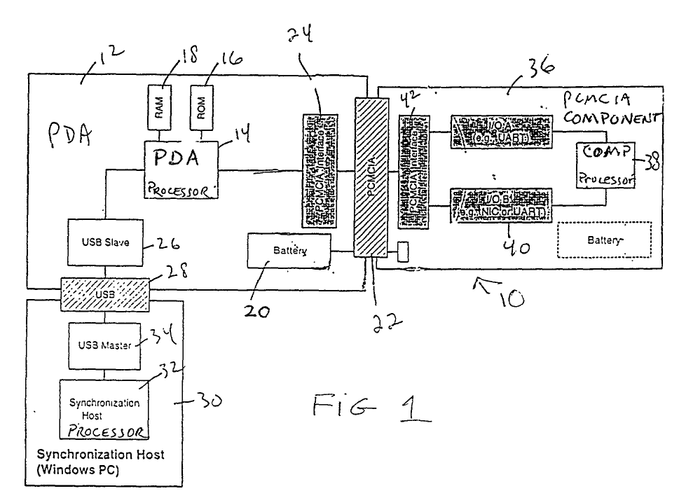

Referring initially to FIG. 1, a system is shown, generally designated 10, which can include a portable computer, referred to herein as a personal digital assistant (PDA) 12. For instance, the PDA 12 can be a Sony Clie® PDA. The PDA 12 may include a PDA processor 14 which can be an Advanced RISC Machine (ARM) processor that accesses read-only memory (ROM) 16 and random access memory (RAM) 18. Also, the PDA 12 may include a rechargeable PDA battery 20 that can supply or receive power through below-described personal computer memory card interface architecture (PCMCIA) mechanical interface 22, a portion of which is on the PDA 12. Further, a PDA PCMCIA electrical interface 24 electrically connects the PDA processor 14 with the PCMCIA mechanical interface 22.

Additionally, for communicating with standard serial data components, the PDA 14 can include an electrical USB slave interface 26 that connects the PDA processor 14 with a USB mechanical interface 28 in accordance with USB principles known in the art. In turn, a synchronization host computer 30 such as a Windows®-based personal computer can be engaged with the PDA 12 using the USB mechanical interface 28, again in accordance with principles known in the art. The host computer 30 can be used to, among other things, synchronize the clock of the PDA 12, download programs thereto, etc. As shown in FIG. 1, the host computer 30 may include a host processor 32 that is operably engaged with the USB mechanical interface 28 by means of a USB master electrical interface 34.

In continued reference to FIG. 1, the system 10 includes a removably engageable component 36 that can be engaged with the PDA 12 in accordance with principles set forth herein to augment the capabilities of the PDA 12. A portion of the PCMCIA mechanical interface 22 is on the component 36. The component 36 may include an engine or processor 38 that communicates with one or more input/output (I/O) devices 40, such as a Universal Asynchronous Receiver Transmitter (UART) or Network Interface Card (NIC). In turn, the I/O devices 40 communicate with a component PCMCIA electrical interface 42 that is electrically connected to the PCMCIA mechanical interface 22.

Non-limiting examples of implementations of the component 36 include PCMCIA or Compact Flash (CF) type 802.11 modem cards, PCMCIA Code Division Multiple Access (CDMA) modem cards, PCMCIA or CF Global System for Mobile Communication (GSM)/General Packet Radio Service (GPRS) modem cards, CF Personal Handyphone System (PHS) modem cards, Wideband CDMA (WCDMA)+ GPRS modem cards, CF pager cards, PCMCIA or CF FM radio or TV tuner cards, PCMCIA Video Graphics Array (VGA) adaptor cards (i.e., video cards), a large battery, CF barcode scanners, and CF No Modulation (XM) radio receiver cards. The component 36 can be a PCMCIA component or a mini-PCMCIA-type component (e.g., CF).

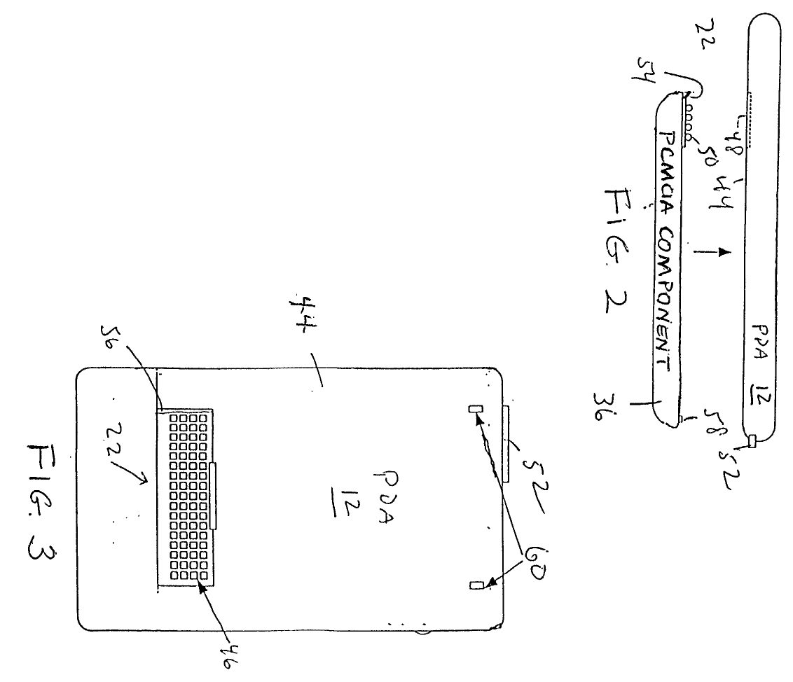

Now referring to FIGS. 2 and 3 for the details of the PCMCIA mechanical interface 22, the interface 22 includes a male portion and a female portion. Preferably, the male portion is on the component 36 and the female portion is on the PDA 12. Accordingly, in cross-reference to FIGS. 2 and 3, the PDA 12 includes a surface 44, preferably the back surface of the PDA, that includes sixty eight (68) electrically conductive female sockets, with the term “sockets” encompassing concave structures as well as pads. Sixty eight sockets 46 are contemplated, since PCMCIA connections require that many, although added sockets can be included. For instance, seventy two (72) female sockets 46 can be provided, with the four extra being used for supporting, e.g., analog audio functions. Or, for mini-PCMCIA applications such as CF, there might be only fifty (50) sockets 46 provided, because that is all that is required for CF. FIG. 2 shows that a removable door 48 can be hingedly engaged with the surface 44 to selectively cover the female sockets 46.

In a preferred embodiment, the layout of the sockets 46 is arranged to minimize the footprint of the PCMCIA mechanical interface 22 in one dimension. Accordingly, as shown in FIG. 3 one preferred non-limiting arrangement of sockets 46 is in a rectangular 4×17 grid. When seventy two sockets are provided, they can be arranged in a 4×18 grid.

As mentioned above, the PCMCIA mechanical interface 22 includes a male portion that mates with some or all of the sockets 46. In the preferred embodiment shown in FIG. 2, plural male pogo pins 50 are provided on the component 36, with each pin 50 registering with a respective socket 46 on the PDA 12. When the component 36 is a PCMCIA component, it will have sixty eight (68) pins 50 (fifty pins for mini-PCMCIA such as CF), although it may include greater or fewer pins if desired. When the sockets 46 are arranged in a 4×17 grid, the pins 50 likewise are arranged in a 4×17 grid.

Per the present invention, the pins 50 are compression loaded, i.e., while the pins themselves may not be resilient but rather are hard and as a practical matter incompressible, they are resiliently biased away from the component 36 and can be compressed back toward the component 36 when pressed against or otherwise engaged with the sockets 46. In one non-limiting embodiment, the compression loading is achieved by mounting the pins 50 on a resilient plastic substrate that forms part of the component 36, although other methods of compression loading, such as providing a compression spring under each pin 50, may be used.

If desired, a removable memory device 52 such as a Sony Memory Stick® can be engaged with the PDA 12. In a preferred embodiment, the mechanical interference between the device 52 and component 36 is minimized. Also, one or more, preferably two, mechanical guide/lever pins 54 can be provided on the component 36 to engage corresponding grooves 56 in the PDA 12 to provide positive contact and to guide the component 36 onto the PDA 12 to prevent misalignment or unintended mechanical interference with the memory device 52. The pins 54/grooves 56 are configured such that a user can insert the pins 54 into the grooves 56 to establish what essentially is a temporary hinge, and then rotate the component 36 about the hinge, toward the PDA.

As the component 36 is moved against the PDA 12, one or more, preferably two, abutments 58 on the component 36 engage complementary catch holes 60 in the PDA 12 in an interference or snapping fit if desired. The abutments 58, which can be spring-loaded, cooperate with the catch holes 60 to detachably hold the component 36 onto the PDA 12 without the need for a sled, although the PDA itself could still be engaged with a sled for recharging.

While the particular INTERFACE FOR PERSONAL DIGITAL ASSISTANT ACCESSORY as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

We claim:

What is claimed is:

1. A system, comprising:
at least one personal digital assistant (PDA);
at least one of: fifty (50) female sockets, and sixty eight (68) female sockets, on the PDA, the female sockets being electrically compatible with personal computer memory card interface architecture (PCMCIA) requirements, the sockets being connected to processing components within the PDA;
at least one component detachably engaged with the PDA; and
plural compression-loaded male pins on the component engaging respective female sockets on the PDA without the need for a sled.

2. The system of claim 1, further comprising at least one guide pin on the component.

3. The system of claim 1, further comprising at least one abutment on one of: the PDA, and the component, configured for engaging a catch hole on the other of: the PDA, and the component.

4. The system of claim 1, wherein the component is one of: a wireless PCMCIA modem, a pager, a radio tuner, TV tuner, a video adaptor, a barcode scanner, and a battery.

5. The system of claim 1, comprising seventy two (72) sockets on the PDA.

6. The system of claim 1, wherein the pins are pogo pins disposed on a plastic substrate.

7. The system of claim 1, wherein the sockets are arranged in a 4×17 grid.

8. The system of claim 3, wherein the abutment is on the component and the catch hole is on the PDA.

9. A personal computer memory card interface architecture (PCMCIA) component, comprising:
a component substrate; and
plural compression-loaded male pins on the substrate, the pins being engageable with respective female sockets on a PDA.

10. The component of claim 9, further comprising at least one guide pin on the component.

11. The component of claim 9, further comprising at least one abutment on one of: the PDA, and the component, configured for engaging, in an interference fit, a catch hole on the other of: the PDA, and the component.

12. The component of claim 9, wherein the component is one of: a wireless PCMCIA modem, a pager, a radio tuner, TV tuner, a video adaptor, a barcode scanner, and a battery.

13. The component of claim 9, comprising at least sixty eight pins.

14. The component of claim 9, wherein the pins are pogo pins disposed on a plastic substrate.

15. The component of claim 13, wherein the pins are arranged in a 4×17 grid.

16. A method for engaging a component with a portable computer, comprising:
providing at least sixty eight sockets on one of: the component, and computer;
providing plural pins on the other of: the component, and the computer, the pins being compression loaded such that when the component and computer are engaged the pins are biased against the sockets; and
holding the component onto the computer without using a sled.

17. The method of claim 16, wherein the holding act is undertaken using at least one abutment on one of: the component, and the computer, and at least one hole on the other of: the component, and the computer, the abutment engaging the hole in an interference fit.

18. The method of claim 16, wherein the computer is a PDA and the component is a PCMCIA component.

19. The method of claim 16, wherein the pins are pogo pins mounted on a resilient plastic substrate.

20. The method of claim 16, further comprising providing at least one guide pin on the component.
